(19) United States
(12) Patent Application Publication
(10) Pub. No.: US 2021/0390524 A1
(43) Pub. Date: Dec. 16, 2021

(54) INTEGRATED MOBILE PAYMENT SYSTEM

(71) Applicant: KARTEK KART VE BILISIM TEKNOLOJILERI TICARET ANONIM SIRKETI, Istanbul (TR)

(72) Inventors: Ahmet AKGÜN, Istanbul (TR); Hasan YASSIBAS, Istanbul (TR)

(21) Appl. No.: 17/287,152

(22) PCT Filed: Feb. 6, 2020
(86) PCT No.: PCT/TR2020/050078

§ 371 Date: Apr. 21, 2021

(30) Foreign Application Priority Data
Mar. 15, 2019 (TR) 2019/03873

(51) Int. Cl. G06Q 20/20; G06Q 20/32

(52) U.S. Cl. CPC G06Q 20/20; G06Q 20/3274

(57) ABSTRACT

Disclosed is a system that enables an acquirer to incorporate less costly and/or different form factors of innovative payment methods into their systems as an alternative to existing on-site payment methods without any change to their existing payment infrastructure.

### TECHNICAL FIELD

The present disclosure relates to a system that enables acquirers incorporate less costly and/or different form factors of innovative payment methods into their systems as an alternative to existing on-site payment methods without any change to their existing payment infrastructure.

### PRIOR ART

Today, mobile payment systems are frequently used in various areas of our lives. In the EMV-based “card present” transactions used in the current technique; the conventional POS devices are connected to the terminal management system of the acquirer as the form factor of the payment recipient device. There is another method that has appeared recently, which uses mobile devices as point of sale devices and where the necessary data for the “card not present” payment process such as card number, the expiration date is accessed by taking a picture of the card or by manually entering it. In this method, the devices are connected to the virtual POS system of the acquirer. In other words, both types of point of sale devices have to be integrated into different systems of the acquirer. In this case, one by one first integration and, subsequently, support efforts and costs are involved. Besides, solutions such as today's appearing SoftPOS, pin-on-glass, mPOS, QR and mobile devices using different hardware/software features, providing sufficient security and function set, that provide mobile devices with the ability to receive payments in different ways will incur additional costs for each of them in terms of integration. Again, there will be one by one effort expending for user interface and experience, back-office configurations, and content management for each system.

As a result, the problems mentioned above and those that cannot be solved using the current technique, have necessitated innovation in the relevant technical field.

### BRIEF DESCRIPTION OF THE INVENTION

The present disclosure relates to an integrated mobile payment system to eliminate the disadvantages mentioned above and bring new advantages to the relevant technical field.

The main purpose of the invention is to provide an integrated payment system that makes it sufficient for the acquirer to integrate into a single port for all different mobile payment modes.

Another purpose of the invention is to create a system that allows the user interface/experience of all mobile payment methods and back-office configurations to be made more easily from a single center.

Another purpose of the invention is to create a system that provides central content management in payment applications and can make flexible and fast breaks such as informing the acquirer, payment method like campaign announcements designed for merchant and customers, merchant code.

Another purpose of the invention is to develop a system that provides a secure communication infrastructure by sharing keys separately with acquirers and mobile point of sale devices and ensures transaction flow regardless of from which device and how (card present/card not present) the transaction comes.

In order to fulfill all the purposes mentioned above and which will appear from the detailed description below, the present invention is an integrated mobile payment system that enables acquirers to integrated innovative payment receiving methods applied on mobile devices to their systems without applying any change to their existing infrastructure.

Accordingly, the system comprises,
An acquirer gate used by the acquirer to receive payment in the field,
a server in order to ensure that the acquirer can receive payment through the different acquirer gates used and that server comprising of;
   an integrated mobile payment gateway that allows the payment receiving process from the acquirer gate used to be forwarded to the relevant module of the acquirer,
   a user interface/experience configuration unit, which configures the user interface/experience for different payment methods and allows the flow to be arranged and adjusted in a variable manner according to the needs,
   a back-office configuration unit, which performs payment configurations for different payment methods and enables the serviced institutions to make administrative configuration and monitoring parameter entries related to the acquirer gates by used through the provided management interface,
   a content management, which allows the content of different payment methods to be managed by parameter configuration and allows the flow to be arranged and adjusted according to content,

In order to be able to understand the advantages of the present invention together with the additional elements, it is necessary to evaluate it with the FIGURES explained below.

### BRIEF DESCRIPTION OF THE FIGURES

FIG. 1 gives a schematic view of the system of subject matter of the invention.

### REFERENCE NUMBERS

1. Integrated mobile payment gateway
2. User interface/experience configuration unit
3. Back-office configuration unit
4. Content management
5. SoftPOS payment system
6. Pin on glass payment system
7. mPOS payment system
8. QR payment system
9. Key in payment system
10. Acquirer
11. Acquirer Gate
12. Server

### DETAILED DESCRIPTION OF THE INVENTION

In this detailed description, novelty of subject-matter of the invention is explained only for a better understanding and without any restrictive effect.

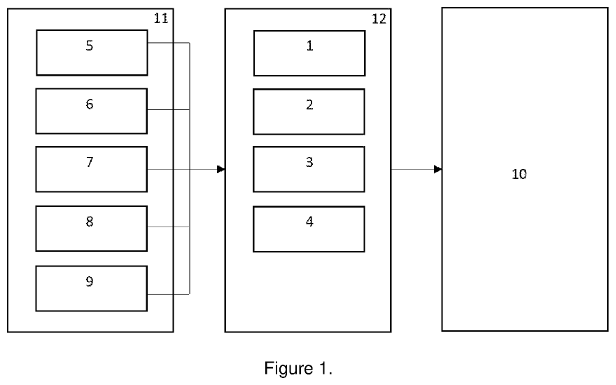

The present invention is an integrated mobile payment system that enables acquirers (10) to integrated innovative payment receiving methods applied on mobile devices to their systems without applying any change to their existing infrastructure. FIG. 1 gives a schematic view of a system of our invention. Accordingly, the system comprises an acquirer gate (11) used by the acquirer (10) to receive payment in the field, a server (12) in order to ensure that the acquirer (10) can receive payment through the different acquirer gates (11) used and that server comprising of; an integrated mobile payment gateway (1) that allows the payment receiving process from the acquirer gate (11) to be forwarded to the relevant module of the acquirer (10), a user interface/experience configuration unit (2), which configures the user interface/experience for different payment methods and allows the flow to be arranged and adjusted in a variable manner according to the needs, a back-office configuration unit (3), which performs payment configurations for different payment methods and enables the serviced institutions to make administrative configuration and monitoring parameter entries related to the acquirer gates (11) by used through the provided management interface, a content management (4), which allows the content of different payment methods to be managed by parameter configuration and allows the flow to be arranged and adjusted according to content.

The user interface/experience configuration unit (2) located on the server (12), which configures the user interface/experience for different payment methods, provides arrangements such as color, image, format, background, moving images, information panels, campaigns, etc. in the interface. With our invention, different acquirer gates (11) can be used by acquirers (10) without requiring any changes to their existing infrastructure. Some acquirer gates (11) that can be used with our invention are:

SoftPOS payment system (5): It is a method in which mobile devices such as smartphones etc. are used in the market as payment receiving devices (or Point-of-Sale, POS).

Contactless payment is made through the NFC antenna by bringing the desired card closer to the mobile device.

Pin on glass payment system (6): There is a separate reader device that reads the card which the payment will be made with or without contactless, but PIN entry is carried out via the mobile device.

mPOS payment system (7): There is a separate device that reads the card with or without contactless and where the PIN is entered. The mobile device initiates transaction and PIN entry.

QR payment system (8): It is a method in which payment data is generated as QR code on the mobile device of the merchant or customer and the customer or merchant initiates the payment flow by reading the QR code.

KeyIn payment system (9): It is the method in which the required information about the payment is received by manual entry or taking the picture of the card and payment info is transferred to the virtual POS system of the acquirer (10).

Our solution offers the opportunity to receive integrated payments; it is sufficient for the acquirer (10) to integrate into a single port for all different acquirer gates (11). The solution will also give an opportunity to the user interface/experience and back-office configurations of all acquirer gates (11) to be made more easily from a single center. Besides, it will provide central content management (4) in payment applications and the acquirers (10) will be able to make announcements for merchant and customers such as informing the acquirer (10), payment method like campaign announcements designed for merchant and customers, merchant code, merchant in a flexible and rapid manner. This solution will, to offer the said features, develop a system that provides a secure communication infrastructure by sharing keys separately with acquirers (10) and mobile point of sale devices and ensures transaction flow regardless of from which device and how (card present/card not present) the transaction comes.

1. An integrated mobile payment system that enables an acquirer to integrated innovative payment receiving methods applied on mobile devices to their systems without applying any change to their existing infrastructure, the system comprising:
an acquirer gate used by an acquirer to receive payment in the field;
a server in order to ensure that the acquirer can receive payment through the different acquirer gates used and comprising:
an integrated mobile payment gateway that allows the payment receiving process from the acquirer gates used to be forwarded to the relevant module of the acquirer;
a user interface/experience configuration unit, which configures the user interface/experience for different payment methods and allows the flow to be arranged and adjusted in a variable manner according to the needs;
a back-office configuration unit, which performs payment configurations for different payment methods and enables the serviced institutions to make administrative configuration and monitoring parameter entries related to the acquirer gates by used through the provided management interface;
a content management, which allows the content of different payment methods to be managed by parameter configuration and allows the flow to be arranged and adjusted according to content.

2. An integrated mobile payment system according to claim 1, wherein said acquirer gates is a SoftPOS payment system.

3. An integrated mobile payment system according to claim 1, wherein said acquirer gates is a pin on glass payment system.

4. An integrated mobile payment system according to claim 1, wherein said acquirer gates is an mPOS payment system.

5. An integrated mobile payment system according to claim 1, wherein said acquirer gates is a QR payment system.

6. An integrated mobile payment system according to claim 1, wherein said acquirer gates is a KeyIn payment system.
